(19) United States
(12) Patent Application Publication
(10) Pub. No.: US 2024/0269617 A1
(43) Pub. Date: Aug. 15, 2024

(54) METHOD FOR OPERATING MEMBRANE-SEPARATION ACTIVATED SLUDGE TREATMENT DEVICE, AND MEMBRANE-SEPARATION ACTIVATED SLUDGE TREATMENT DEVICE

(71) Applicant: Toray Industries, Inc., Tokyo (JP)

(72) Inventors: Yohito Ito, Otsu-shi, Shiga (JP); Seiko Kantani, Otsu-shi, Shiga (JP); Genki Inagaki, Otsu-shi, Shiga (JP)

(73) Assignee: Toray Industries, Inc., Tokyo (JP)

(21) Appl. No.: 18/567,966

(22) PCT Filed: Jun. 24, 2022
(86) PCT No.: PCT/JP2022/025314

§ 371 Date: Dec. 7, 2023

(30) Foreign Application Priority Data
Jun. 28, 2021 (JP) 2021-106387

(51) Int. Cl. B01D 65/02; C02F 3/12

(52) U.S. Cl. CPC B01D 65/02; C02F 3/1273; B01D 2321/16; B01D 2321/40; B01D 2325/02834; C02F 2209/008; C02F 2209/11; C02F 2303/16

(57) ABSTRACT

An object of the present invention is to provide a specific method for determining the fouling potential of an activated sludge solution on the basis of the characteristics of the activated sludge solution after chemical cleaning of a membrane, and to provide a suitable method for resuming operation in a rational manner after chemical cleaning of the membrane, while accurately determining the degree of recovery of the membrane filtration characteristics for the activated sludge solution. Moreover, an object of applying the present invention is to enable more effective suppression of an increase in a transmembrane pressure difference after chemical cleaning than in the prior art, leading to a reduction in the cleaning frequency of the membrane and a reduction in the used amount of cleaning chemicals and to extension of the life of the membrane.

The present invention relates to a method for operating a membrane-separation activated sludge treatment device after chemical cleaning of a membrane, the method including, after the chemical cleaning of the membrane is completed, controlling an operating condition until a normal filtration operation is resumed on the basis of characteristics of an activated sludge solution.

### CROSS REFERENCE TO RELATED APPLICATIONS

This application is the U.S. National Phase of PCT/JP2022/025314, filed Jun. 24, 2022, which claims priority to Japanese Patent Application No. 2021-106387, filed Jun. 28, 2021, the disclosures of these applications being incorporated herein by reference in their entireties for all purposes .

### FIELD OF THE INVENTION

The present invention relates to a method for operating a membrane-separation activated sludge treatment device including a membrane module that is immersed in a biological treatment tank to filter activated sludge. In particular, the present invention relates to a method for resuming operation after chemical cleaning is performed in a state where a membrane module is immersed in a biological membrane treatment tank.

### BACKGROUND OF THE INVENTION

The membrane separation activated sludge method is a wastewater treatment method for treating sewage, industrial wastewater, and the like. In the membrane separation activated sludge method, sewage and wastewater are purified using activated sludge, and then the activated sludge is separated by solid-liquid separation using a membrane module immersed in a water tank, so that clear membrane-filtered water can be obtained as treated water.

In this membrane separation activated sludge method, since treated water is obtained by solid-liquid separation using a membrane, clogging (fouling) of the membrane associated with continuous operation of the membrane module cannot be avoided. When the activated sludge solution is filtered using the membrane module, air is diffused from a diffuser tube disposed below the membrane module, and filtration is performed so that the membrane surface is physically cleaned constantly by the generated upward flow. However, it is difficult to sufficiently suppress the progress of clogging of the membrane for a long period of time under continuous operation. Therefore, at the timing when the transmembrane pressure difference (or membrane filtration resistance) increases, the timing after the membrane module is operated for a certain period of time, or the like, an operation, or chemical cleaning, of chemically washing the membrane using a chemical solution to restore the water permeability of the membrane is performed.

However, when the filtration operation is resumed immediately after the chemical cleaning at a high flux during normal operation, the membrane module is rapidly clogged with fouling materials. This is because the activated sludge is damaged by the chemical solution flowing out into the sludge during the chemical cleaning of the membrane, and the generated soluble organic matter, suspended matter particles, and the like are adsorbed to the membrane or blocked by the pores of the membrane. Then, the transmembrane pressure difference rapidly increases immediately after the start of the filtration operation, and the pressure difference increase rate during the subsequent filtration operation also increases. As a result, there has been a case where the frequency of chemical cleaning of the membrane for recovering the performance of the membrane increases.

In particular, in wastewater treatment plants such as low-BOD-concentration wastewater and sewage projects that are designed to have a high flux during normal operation, that is, a high membrane flux (0.5 m/d or more as a standard), such a problem often occurs when a membrane is subjected to chemical cleaning with a chemical treatment strength (a standard is the case where a sodium hypochlorite solution having an effective chlorine concentration of 1,000 mg/L or more is used) of a certain level or more.

As a method for solving the above-described problems, Patent Document 1 discloses a method in which after a membrane module is subjected to chemical cleaning and before the filtration is resumed, air for aerating the membrane surface is supplied from below the membrane module for an appropriate time to peel off the membrane surface deposit.

Further, Patent Document 2 discloses a method for operating a membrane-separation activated sludge treatment device after chemical cleaning of a membrane, in which after chemical cleaning, instead of abruptly resuming normal filtration operation, filtration operation is started at a flux set to a value of 50% or less of a target flux, the flux is increased stepwise or continuously to the target flux within a predetermined time from the start of filtration, and after that, the target flux is held during filtration until the next cleaning.

Patent Document 3 discloses, as an operation method focusing on improvement of operability at the time of resuming operation after chemical cleaning, a membrane cleaning method in which, in order to maintain the activity of activated sludge in an activated sludge tank during chemical cleaning, a swirling flow that circulates outside a membrane module is generated by an diffuser unit including diffuser means provided outside the membrane module, and a water flow does not substantially act on a membrane surface of the membrane unit.

### PATENT DOCUMENTS

Patent Document 1: Japanese Patent No. 3290558

Patent Document 2: Japanese Patent Laid-open Publication No. 2005-246283

Patent Document 3: Japanese Patent No. 4244001

### SUMMARY OF THE INVENTION

However, in the conventional art disclosed in these patent documents, a determination index and a determination method for determining an operating condition after the chemical cleaning of the membrane are not specifically disclosed, and it is not possible to rationally determine what condition is to be satisfied after the chemical cleaning of the membrane to enable resuming of the normal filtration operation.

Therefore, when air is diffused to the membrane module without filtration according to the method described in Patent Document 1 or when filtration is resumed at a flux set to a value of 50% or less of the target flux according to the method described in Patent Document 2, there are the following problems. When the normal filtration operation is resumed in a short time or the flux is returned to the target flux in a short time, the activated sludge is damaged by the contact between the activated sludge solution and the chemical solution such as a sodium hypochlorite solution flowing out from the secondary side to the primary side of the membrane module, and fouling materials that clog the separation membrane, such as the generated activated sludge-derived organic substances such as polysaccharides and proteins, remain undecomposed at a high concentration. Therefore, there is a problem that the cleaned membrane is immediately clogged, and the operation time until the next chemical cleaning is shortened.

On the contrary, when the return to the target flux takes a long time, there is a problem that a burden is imposed on other facilities. For example, a large flow rate control tank is required, or when there are a plurality of membrane module lines, a burden of treatment to other lines increases.

In addition, in the method of generating a swirling flow that circulates outside the membrane module with the diffuser unit including the diffuser means provided outside the membrane module of Patent Document 3, there is a problem that a flow is generated on the membrane surface by the swirling flow generated by the diffuser unit including the diffuser means provided outside the membrane module during the chemical cleaning, leading to a decrease in the recovery efficiency of the membrane after the chemical cleaning.

An object of the present invention is to provide a specific method for determining the fouling potential of an activated sludge solution on the basis of the characteristics of the activated sludge solution after chemical cleaning of a membrane, and to provide a method for resuming operation in a rational manner after chemical cleaning of the membrane, while accurately determining the degree of recovery of the membrane filtration characteristics for the activated sludge solution.

Moreover, an object of applying the present invention is to enable more effective suppression of an increase in a transmembrane pressure difference after chemical cleaning than in the prior art, leading to a reduction in the chemical cleaning frequency of the membrane and a reduction in the used amount of cleaning chemicals and to extension of the lives of the separation membrane and the separation membrane module.

In order to solve the above-mentioned problems, the present invention has the following constitution.

(1) A method for operating a membrane-separation activated sludge treatment device including an activated sludge tank configured to treat water to be treated with activated sludge; a membrane module immersed in the activated sludge tank; diffuser means disposed below the membrane module; and permeated water discharge means configured to discharge permeated water having permeated through the membrane module to outside of the device,

the method including: interrupting filtration operation after filtration operation is performed; injecting a chemical solution for cleaning from a permeated water discharge side of the membrane module with the membrane module immersed in the activated sludge tank to perform chemical cleaning of a separation membrane in the membrane module; and then resuming the filtration operation,

in which preliminary operation satisfying a condition A or a condition B below is performed after the separation membrane is subjected to the chemical cleaning, and the filtration operation is resumed after a characteristic derived from a fouling material in an activated sludge solution satisfies a preset first criterion.

Condition A: Air diffusion from the diffuser means having been interrupted during the chemical cleaning of the membrane is resumed.

Condition B: Air diffusion from the diffuser means having been interrupted during chemical cleaning of the membrane is resumed, and preliminary filtration operation is performed at a flux of 40% or less of a flux during the filtration operation.

(2) The method for operating a membrane-separation activated sludge treatment device according to (1), in which, after the chemical cleaning of the separation membrane, the preliminary operation satisfying the condition A or the condition B is performed, preparatory operation satisfying a condition C below is performed after the characteristic derived from the fouling material in the activated sludge solution satisfies a preset second criterion, and the filtration operation is resumed after the characteristic derived from the fouling material in the activated sludge solution satisfies the preset first criterion.

Condition C: Second preliminary filtration operation is performed at a flux of 50% or more and 80% or less of the flux during the filtration operation.

(3) The method for operating the membrane-separation activated sludge treatment device according to (1) or (2), in which the characteristic derived from the fouling material in the activated sludge solution is any one of a turbidity of a filter paper filtrate of the activated sludge solution, image information from a microscope showing a floc region, a membrane filtration resistance calculated from a result of a membrane filtration test using a membrane piece, a TOC concentration in the filter paper filtrate, and a TOC concentration in a membrane filtrate.

(4) The method for operating the membrane-separation activated sludge treatment device according to any one of (1) to (3), in which the characteristic derived from the fouling material in the activated sludge solution is any one of a turbidity of a filter paper filtrate of the activated sludge solution, image information from a microscope showing a floc region, and a membrane filtration resistance calculated from a result of a membrane filtration test using a membrane piece, and the filtration operation is resumed after the preset first criterion satisfies any one of Formula 1 to Formula 3.

### Turbidity of Filter Paper Filtrate of Activated Sludge Solution

Turbidity of filter paper filtrate [NTU]≤turbidity of filter paper filtrate before chemical cleaning+4 [NTU] Formula 1

### Image Information of Microscope Showing Floc Region

Total area of flocs with area of 200 μm² or less [μm²]/area of microscopic field [μm²]≤(total area of flocs with area of 200 μm² or less before chemical cleaning [μm²]/area of microscopic field [μm²])×1.3 Formula 2

### Membrane Filtration Resistance Calculated from Result of Membrane Filtration Test Using Membrane Piece

Value of increase in membrane filtration resistance≤value of increase in membrane filtration resistance before chemical cleaning×2.5 Formula 3.

(5) The method for operating the membrane-separation activated sludge treatment device according to any one of (2) to (4), in which the characteristic derived from the fouling material in the activated sludge solution is a turbidity of a filter paper filtrate of the activated sludge solution, and the filtration operation is resumed after the preset second criterion satisfies Formula 4 and the preset first criterion satisfies Formula 1.

Turbidity of filter paper filtrate [NTU]≤ value of turbidity of filter paper filtrate before chemical cleaning+8 [NTU] Formula 4.

(6) The method for operating the membrane-separation activated sludge treatment device according to any one of (1) to (5), in which a pore size of the separation membrane used in the membrane module is 0.01 μm or more and less than 1 m.

(7) The method for operating the membrane-separation activated sludge treatment device according to (1) to (6), in which the characteristic of the activated sludge solution is measured before and after the chemical cleaning, and normal filtration operation is resumed on the basis of a result of the measurement of the characteristic.

(8) The method for operating the membrane-separation activated sludge treatment device according to (7), in which information obtained by measuring the characteristic of the activated sludge solution before and after the chemical cleaning is judged by judging means provided at a remote location connected by a communication device, a control condition related to resumption of the normal filtration operation is output when a judgment result satisfies a preset criterion, and the normal filtration operation is resumed according to the output control condition.

(9) A membrane-separation activated sludge treatment device including: an activated sludge tank configured to hold an activated sludge solution for treating water to be treated; a membrane module immersed in the activated sludge tank; diffuser means disposed below the membrane module; permeated water discharge means configured to discharge permeated water having permeated through the membrane module to outside of the device; a data storage unit configured to store information on measurement of a characteristic of the activated sludge solution before and after chemical cleaning from after normal filtration operation is performed until the normal filtration operation is resumed after the chemical cleaning of a separation membrane in the membrane module; a communication device configured to transmit the information to a remote location; and a controller configured to control the resumption of the normal filtration operation on the basis of the characteristic of the activated sludge solution before and after the chemical cleaning.

(10) The membrane-separation activated sludge treatment device according to (9), in which the controller is a management program configured to cause a computer to run as means for collecting activated sludge; means for measuring the characteristic of the collected activated sludge solution; means for making a judgement on the basis of a result of measuring the characteristic of the activated sludge solution; means for outputting an operation control condition on the basis of a judgement result; and means for resuming the normal filtration operation in accordance with the output control condition, and a part of the management program is executed via judging means provided at the remote location connected by the communication device.

The risk of membrane contamination after chemical cleaning can be minimized by resuming the normal operation while grasping the recovery of the membrane filtration characteristic of the activated sludge solution after chemical cleaning of the membrane. Therefore, the increase in the transmembrane pressure difference after the chemical cleaning can be more effectively suppressed than in conventional cases, which leads to a reduction in the frequency of cleaning the membrane and a reduction in the amount of chemicals used for cleaning. The conditions of the wastewater treatment are variable, and the state such as the activity and filtration characteristics of the activated sludge solution constituted of microorganisms changes according to the change of the conditions, so that the resumption of the filtration operation missing the timing based on “appropriate time”, “predetermined time”, “certain time”, and the like of the conventional art is prevented.

According to the present invention, by resuming the filtration operation on the basis of an evaluation index derived from the fouling material in the activated sludge solution after the chemical cleaning, the filtration operation can be resumed reliably and securely, and the filtration operation time until the next chemical cleaning can be extended. Further, the lives of the separation membrane and the separation membrane module are prolonged.

### BRIEF DESCRIPTION OF THE DRAWINGS

FIG. 1 schematically shows an example of the configuration of a membrane-separation activated sludge treatment device.

FIG. 2 is a graph showing the characteristic of the turbidity of a filter paper filtrate of an activated sludge solution before and after chemical cleaning.

FIG. 3 is a graph showing the characteristic of the amount of the filter paper filtrate of the activated sludge solution before and after chemical cleaning.

FIG. 4 is a graph showing the characteristic of the filtration resistance of the activated sludge solution before and after chemical cleaning.

FIG. 5 schematically shows image information showing a flux region of the activated sludge solution before and after chemical cleaning.

FIG. 6 is a graph showing the characteristic of the filter paper filtrate of the activated sludge solution before and after chemical cleaning.

### DETAILED DESCRIPTION OF EMBODIMENTS OF THE INVENTION

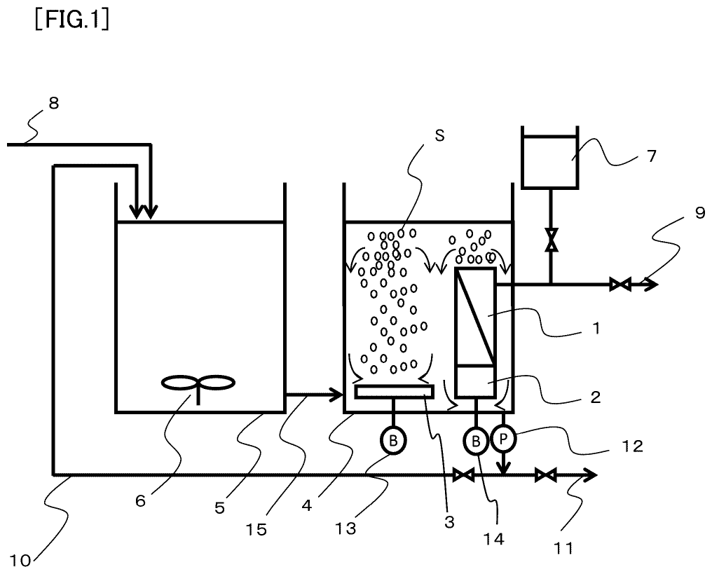

Hereinafter, an embodiment of the present invention will be described on the basis of FIG. 1. Note that the present invention is not limited to the embodiment exemplified below.

A membrane-separation activated sludge treatment device used in the present invention includes a membrane module 1 for subjecting water to be treated such as sewage and organic wastewater to biological treatment with activated sludge and then to solid-liquid separation and an activated sludge tank 4 for immersing the membrane module and includes, as basic components, diffuser means (a diffuser tube 2 for the membrane module) for air-cleaning a separation membrane, an air supply device 14 for sending air to the diffuser means, a gravity filtration facility or a suction pump (not shown) for taking in treated water from the activated sludge tank, and a chemical solution tank 7 for storing a chemical solution for cleaning. In addition, if necessary, it is constituted of auxiliary diffuser means (auxiliary diffuser tube 3) for supplying oxygen and an air supply device 13 for sending air to the auxiliary diffuser means, which are different from those for air-cleaning the separation membrane. Furthermore, a treatment tank 5 other than the activated sludge tank for immersing the membrane module, such as an anoxic tank for denitrification under an oxygen-free condition, is appropriately added.

The shape of the membrane of the membrane module in the membrane-separation activated sludge treatment device used in the present invention is not particularly limited but may be any of a flat membrane, a hollow fiber membrane, a tubular membrane, and the like.

The membrane structure is also not particularly limited, but the pore size of the membrane is preferably 0.01 μm or more and less than 1 μm in consideration of the balance between the blocking property of suspended matter in the activated sludge solution and the filtration performance (ease of water extraction) at the time of filtration of the activated sludge solution. The membrane may be any porous membrane that satisfies this requirement, such as a microfiltration membrane and an ultrafiltration membrane, but the pore size is particularly 0.05 μm or more and less than 0.5 μm as a more preferable requirement.

The membrane material is also not particularly limited, and specific examples of the membrane include porous membranes such as a polyacrylonitrile porous membrane, a polyimide porous membrane, a polyether sulfone porous membrane, a polyphenylene sulfide sulfone porous membrane, a polytetrafluoroethylene porous membrane, a polyvinylidene fluoride porous membrane, a polypropylene porous membrane, and a polyethylene porous membrane, and the polyvinylidene fluoride porous membrane and the polytetrafluoroethylene porous membrane are particularly preferable because they have high chemical resistance.

The activated sludge tank 4 is not particularly limited as long as it stores the water to be treated and the activated sludge solution and can immerse and accommodate the membrane module in the activated sludge solution in a layout (the distance to a wall, the distance from the membrane module to the water surface, and the like) that meets requirements of a membrane module supplier, and examples thereof include a concrete tank, a stainless steel tank, and a fiber-reinforced plastic tank. The inside of the activated sludge tank 4 may be a single space or a space divided by a partition plate (partially having an opening) or the like. In the case where the activated sludge tank is physically divided into a plurality of sections, or even in the case of a single space, one section may be used as a section for installing the membrane module 1 in an immersed manner, and another section may be used as a treatment section for performing auxiliary air diffusion or denitrification, so that the space may be divided into a plurality of sections having different functions and used.

The diffuser tube 2 for the membrane module is not particularly limited as long as it has a structure that can diffuse air such that generated bubbles can be uniformly applied to the entire surface on the activated sludge solution side (primary side) of the membrane, and a tube having a perforated structure, a diffuser plate made of rubber or ceramic, or the like can be used. The air sent by the air supply device 14 for the diffuser tube for the membrane module is supplied to the membrane module 1 by the diffuser tube 2 for the membrane module, and the membrane surface is physically cleaned by air diffusion. The air supply device 14 for the diffuser tube for the membrane module is a device that blows compressed air, and a blower, a compressor, or the like is generally used.

The membrane surface air diffusion from the diffuser means disposed below the membrane module during the filtration operation may be continuously performed or may be intermittently performed by repeating operation for 10 seconds and interruption for 10 seconds.

In addition to the air diffusion to the membrane module, an auxiliary diffuser system constituted of the air supply device 13 and the auxiliary diffuser tube 3 for supplying oxygen may be provided. As the auxiliary diffuser tube, a fine bubble diffuser tube excellent in oxygen supply efficiency is preferably used.

As permeated water discharge means (not shown) for separating permeated water through the membrane module from the activated sludge solution, a suction pump may be used, or a method in which filtration is performed by a hydraulic head pressure difference without using a suction pump may be adopted. When a suction pump is used, there is no particular problem as long as it is a pump that can provide treated water from the membrane module 1 with less pulsation, and a volute pump, a diffuser pump, a volute mixed flow pump, a mixed flow pump, a piston pump, a plunger pump, a diaphragm pump, a gear pump, a screw pump, a vane pump, a cascade pump, a jet pump, or the like is used. When filtration is performed by a hydraulic head pressure difference without using a suction pump, a flow control valve is provided to control the flow rate.

Normal filtration operation is performed using the device having the above configuration, and then the chemical cleaning of the membrane is performed. Here, the normal filtration operation refers to operation in a state where there are no or few membrane modules stopped due to chemical cleaning, maintenance, or the like in the entire wastewater treatment plant, all or most of the membrane modules installed in the plant are used for wastewater treatment, and a necessary amount of water is filtered. The normal filtration operation is also simply referred to as filtration operation. When the chemical cleaning of the membrane is performed, the filtration operation is interrupted, and the membrane surface air diffusion is also interrupted. Here, interruption means stopping the operation during the chemical cleaning, but the case where the operation is temporarily performed for a short time during the chemical cleaning is also included in the interrupted state of the operation.

In general, the chemical cleaning is performed at a timing when the transmembrane pressure difference (or the membrane filtration resistance) has increased to a certain value or more or at a timing after the membrane module is operated for a certain period of time, but the chemical cleaning may be performed at any timing instead of these timings.

The chemical solution in the present invention is injected from the permeate side (secondary side) to the activated sludge side (primary side) of a membrane element in a state where the membrane module is immersed in the activated sludge solution after the filtration operation is interrupted. As a method for bringing the chemical solution into contact with the membrane, there are a method of taking out the entire membrane module from the membrane separation activated sludge tank and immersing the membrane module in a chemical cleaning tank, and a method of emptying the membrane separation activated sludge tank and then storing the chemical solution in the tank to bring the membrane into contact with the chemical solution. However, large-scale accompanying devices are required for the methods, which are uneconomical.

In FIG. 1, the chemical solution is stored in the chemical solution tank 7 and is supplied to the permeate side of the membrane module using a hydraulic head difference or a pump. A chemical solution storage tank may be provided on the ground to supply the chemical solution to the chemical solution tank. Here, as the chemical solution used for cleaning, a chemical solution according to the contamination of the membrane may be used, but to recover the membrane performance, sodium hypochlorite having an effective chlorine concentration of about 500 mg/L to 6,000 mg/L is usually effective for the contamination by organic substances, and an organic acid having a chelating effect such as oxalic acid and citric acid at a concentration of about 1 to 3 mass % is effective for the contamination by inorganic substances, so that these substances are preferably used.

The chemical solution immersion time for removing (cleaning) contaminants clogging the membrane by chemical reaction by decomposition and dissolution after completion of injection of the chemical solution to the secondary side of the membrane element may be appropriately set according to the degree of clogging (increase in pressure difference) of the membrane at the time of chemical cleaning, the water temperature, and the like, and normally, a range of 30 minutes to 4 hours, more preferably 1 to 2 hours can be exemplified as a suitable chemical solution immersion time. Since the concentration of the injected chemical solution on the membrane surface decreases due to consumption by the reaction or diffusion, the effect is low if the immersion is performed for an unnecessarily long time. On the other hand, if the chemical solution immersion time is too short, unreacted and undecomposed foulants remaining in the membrane increase, which is not preferable, and the immersion time is preferably 30 minutes or more.

As the injection amount of the chemical solution, it is desirable to estimate the total capacity on the secondary side from the chemical solution injection portion to the membrane surface, such as the secondary side capacity of the membrane module, a water collection tube, and a permeated water pipe and to inject a chemical solution amount equal to or more than the estimated capacity, because the chemical solution can be reliably supplied to the membrane surface on the primary side (the side where the activated sludge solution exists) of the membrane. However, if the amount of the chemical solution injected is too large, the amount of the chemical solution flowing out of the membrane into the activated sludge solution also increases accordingly, and only the adverse effect of damaging the activated sludge increases regardless of the recovery of the membrane performance. Therefore, it is necessary to take care not to inject too much chemical solution.

While the chemical cleaning by reacting the injected chemical solution with the fouling materials on the membrane to remove the fouling materials from the membrane is performed, air diffusion on the membrane module is interrupted in order to keep the chemical solution flowing out to the primary side of the membrane on the surface of the membrane and effectively use the chemical solution for the reaction. For the same reason, during the chemical cleaning, it is preferable to interrupt such operation as to generate a flow of sludge in the vicinity of the membrane surface, which moves the chemical solution flowing out to the primary side of the membrane away from the membrane surface.

Specifically, depending on the configuration of the plant, when a sludge return (circulation) pump, auxiliary diffuser means installed in a separate section in a membrane-separation activated sludge tank in which the membrane module is installed, or the like is installed, it is preferable that these devices that may generate a flow on the membrane surface are also stopped during the chemical cleaning.

In the present invention, after completion of the chemical cleaning of the membrane, one of the following types of operation is performed, and the normal filtration operation is resumed after the characteristic of the activated sludge solution satisfies a preset criterion.

(Condition A) Air diffusion from the diffuser means installed below the membrane module having been interrupted during the chemical cleaning of the membrane is resumed.

(Condition B) Air diffusion from the diffuser means installed below the membrane module having been interrupted during the chemical cleaning of the membrane is resumed, and the filtration operation is resumed at a flux set to a value of 40% or less of a flux during the normal filtration operation.

The condition A corresponds to 0% of the flux during the normal filtration operation in the condition B. A predetermined time, which is a feature of the present invention, is determined on the basis of the characteristic of the activated sludge solution described later. Here, the step corresponding to the chemical cleaning is defined as a process from the completion of the chemical solution injection from the permeate side (secondary side) of the membrane element to the resumption of membrane surface air diffusion from the diffuser means of the membrane module.

In addition, the flux during the normal filtration operation refers to a flux when there are no or few membrane modules whose operation is interrupted due to chemical cleaning, maintenance, or the like in the entire wastewater treatment plant, all or most of the membrane modules installed in the plant are used for wastewater treatment, and a required amount of water is filtered. The flux is usually equivalent to the average filtration flux before the chemical cleaning is performed. When it is necessary to clarify the definition, for the sake of convenience, a value obtained by dividing the average amount of filtered water (treated water amount) in the most recent one month before chemical cleaning is performed by the total area of the membranes of the membrane modules used in the plant is defined as the flux during the normal filtration operation.

In the present invention, after the completion of the chemical cleaning of the membrane and before resuming the normal filtration operation, air diffusion is resumed for a predetermined time, or simultaneously with resumption of air diffusion the filtration operation is performed at a flux set to a value of 40% or less of the flux during the normal filtration operation, because the following effects are obtained.

First, in a state where filtration is interrupted or under a filtration operating condition of 40% or less of the flux during the normal filtration operation, air diffusion from the diffuser means installed below the membrane module is resumed, and an activated sludge solution having high filtration resistance, which is strongly damaged by the chemical solution in the vicinity of the membrane surface, such as an activated sludge solution between membranes, is mixed with sludge in an area not (less) affected by the chemical solution, so that membrane contaminants can be quickly moved away from the membrane surface. As a result, the filtration characteristics of the sludge on the membrane surface can be improved in a short time, and the risk of fouling of the membrane when the flux is increased and the normal filtration operation is resumed can be significantly reduced.

Secondly, by supplying oxygen or performing mixing by air diffusion in a state where the filtration is interrupted or under a filtration operating condition of 40% or less of the flux during the normal filtration operation, which involves only a little fouling risk to the membrane, it is made possible to adsorb, decompose, and aggregate, on the activated sludge, fouling materials (soluble organic substances, viscous substances, micronized flocs, and the like) derived from activated sludge damaged by chemical cleaning. Therefore, it is possible to suppress membrane contamination when the normal filtration operation is resumed, such as pore adsorption and membrane surface adhesion due to fouling materials derived from activated sludge damaged by chemical cleaning. The time required for re-aggregation of the activated sludge flocs broken by chemical cleaning and aggregation of organic substances into the flocs can also be secured, and the filtration resistance of sludge during normal filtration operation can be reduced.

Here, in order to suppress the contamination of the membrane due to the fouling materials derived from activated sludge damaged by chemical cleaning to the maximum extent, it is most preferable not to perform filtration, and control to resume only air diffusion for a predetermined time before resuming the filtration operation can be mentioned as an aspect. Also for sludge with deteriorated properties, control can be mentioned as an aspect in which air diffusion from the diffuser means installed below the membrane module is resumed, and the preliminary filtration operation is performed at a flux in a range of a low level in which dirt can be reversibly removed from the membrane surface, that is, 40% or less of the flux during the normal filtration operation. This is because when the flux is 40% or less of the flux during the normal filtration operation, the risk of causing serious membrane re-contamination is low. That is, by performing the preliminary operation satisfying the condition A or the condition B after the chemical cleaning of the separation membrane, the characteristic derived from the fouling material in the activated sludge solution can be reduced to a preset first criterion or less.

Here, when there is a treatment tank other than the activated sludge tank for immersing the membrane module, or when the inside of the activated sludge tank is functionally divided into a section in which the membrane module is installed and other sections, it is more effective to simultaneously mix the activated sludge solution around the membrane module and the activated sludge solution at a position distant from the membrane module in order to improve the filtration characteristics of the sludge in the vicinity of the membrane module in a shorter time.

Specifically, when there is a section different from the section in which the membrane module is installed in the activated sludge tank, and the diffuser means or stirring means is provided in the other section, it is preferable to operate these means simultaneously with air diffusion from the diffuser means of the membrane module from the viewpoint of promoting mixing and reaction. When a tank independent of the activated sludge tank is provided, it is preferable to operate a sludge return pump to circulate the sludge in the whole so that the activated sludge solutions in these tanks can be efficiently mixed. When the diffuser means or the stirring means is provided in a treatment tank other than the activated sludge tank for immersing the membrane module, it is preferable to operate these means at the same time from the viewpoint of promoting mixing and reaction.

Here, before resuming the normal filtration operation, if the time for performing membrane surface air diffusion from the diffuser means installed below the membrane module in an operation state of 40% or less of the flux during the normal filtration operation or the time for mixing the activated sludge solution around the membrane module and the activated sludge solution at a position distant from the membrane module is too short, it is impossible to secure the time required for homogenization of sludge characteristics in the entire facility by mixing soluble organic substances derived from the activated sludge damaged by chemical cleaning with sludge not damaged by the chemical solution or the time required for improvement of sludge filtration characteristics by biological treatment of fouling materials with the activated sludge (decomposition of organic substances generated by chemical cleaning) or physical treatment (adsorption or aggregation). In order to resume the normal filtration operation, it is preferable to perform the preliminary operation for a predetermined time or more, and it is necessary to reduce the characteristic of the activated sludge solution to the criterion or less.

On the other hand, if the time in which operation is performed at a flux of 40% or less of the flux during the normal filtration operation is too long, organic substances in the activated sludge solution and nutrients accumulated by the activated sludge in the activated sludge itself are depleted, and the sludge becomes starved, which leads to generation of substances that increase fouling of the membrane, such as breakage of flocs and killing and autolysis of microorganisms, so that this case is not preferable. Therefore, the time is desirably within a predetermined time. These predetermined times are determined on the basis of the characteristic of the activated sludge solution described later.

Here, in the present invention, there can also be applied an operation method in which, after completion of the chemical cleaning of the membrane, air diffusion from the diffuser means that has been interrupted during cleaning of the membrane by injecting the chemical solution for cleaning from the permeate side of the membrane module in a state where the membrane module is immersed in the activated sludge tank, or simultaneously with resumption of the air diffusion, filtration operation is resumed at a flux set to a value of 40% or less of the flux during the normal filtration operation, the filtration operation is changed to filtration operation at a flux set to a value of 50% to 80% of the flux during the normal filtration operation after the characteristic of the activated sludge solution satisfies a preset second criterion, and the normal filtration operation is resumed after the characteristic of the activated sludge solution satisfies the preset first criterion. The preliminary operation before the second criterion is satisfied may be under the condition A without the preliminary filtration operation or under the condition B in which the preliminary filtration operation at a flux set to a value of 40% or less of the flux during the normal filtration operation is performed. That is, regardless of whether the preliminary filtration operation is performed, it is also preferable to perform second preliminary filtration operation at a flux of 50% or more and 80% or less of that in the filtration operation while continuing membrane surface air diffusion after the second criterion is satisfied.

Here, the reason why preparatory operation at a flux set to a value of 50% to 80% of the flux during the normal filtration operation is performed for a predetermined time before resuming the normal filtration operation is to provide the following effect.

First, even after the sludge characteristics are improved by resuming air diffusion or performing the filtration operation at a flux set to a value of 40% or less of the flux during the normal filtration operation while air diffusion is resumed, the membrane may be clogged if the recoverability of the water permeability (or the transmembrane pressure difference) of the membrane by chemical cleaning is evaluated at a flux abruptly set to a normal flux (high flux). By performing the preparatory operation at a value of 50% to 80% of the flux during the normal filtration operation, the degree of recovery of membrane water permeability by chemical cleaning can be evaluated, and the membrane clogging risk when the filtration operation at a high flux is resumed can be further reduced or avoided. Specifically, in the case of a plant having a normal operation flux of 0.6 m/d, 0.4 m/d is one of preferable aspects. At a flux of 40% or less of the flux during the normal filtration operation, the differential pressure difference is small, and it is difficult to evaluate and analyze the membrane recoverability after chemical cleaning. Therefore, the determination of the degree of recovery of membrane performance by chemical cleaning may be performed at a flux of 50% to 80% of the flux during the normal filtration operation.

Secondly, when the sludge is largely damaged by chemical cleaning and it takes time to recover the sludge state, if the sludge is to be healed (recover the filtration characteristics) by air diffusion or by resuming air diffusion and performing only filtration operation at a flux set to a value of 40% or less of the flux during the normal filtration operation, deterioration of the sludge property due to the shortage of food with respect to the sludge amount may occur from the middle. Therefore, by providing a certain period of time during which the operation is performed at a flux of 50% to 80% of the flux during the filtration operation as the preparatory operation between the operation of only air diffusion or the filtration operation at a flux set to a value of 40% or less of the flux during the normal filtration operation along with resumption of air diffusion, and the normal operation, it is possible to minimize the load variation/stress change on the sludge, to achieve both the healing of damaged sludge and the maintenance of the healthy sludge function, and to achieve smooth return to the normal operation.

In the case of a plant in which wastewater is treated using a plurality of lines of membrane-separation activated sludge tanks in which membrane modules are immersed, during chemical cleaning, it is also possible to reduce the burden of wastewater treatment on other lines not performing chemical cleaning. Since the predetermined time for the present purpose depends on the sludge recovery speed associated with the degree of sludge damage caused by the chemical solution, the water temperature, and the like and varies depending on the situation, more appropriate operation management can be performed by controlling the operating conditions on the basis of the characteristic of the sludge described later. The method for determining this predetermined time is determined on the basis of the characteristic of the activated sludge solution described later.

As described above, the operating conditions of the activated sludge treatment device depend not only on the condition of the activated sludge but also on the configuration of the treatment tank, the condition of treated wastewater, the design flux of the membrane module, and the like. Therefore, a stable operation resumption condition cannot be determined by evaluating the recovery of the membrane characteristics of the membrane module. Focusing on the characteristics of the activated sludge solution of the present invention derived from fouling materials, an index serving as the criterion for resuming the operation was found. Further provided is a method for operating the activated sludge treatment device after chemical solution treatment, the method being capable of reproducibly evaluating the characteristic of the activated sludge solution as the index. In particular, in the present invention, the time during which only air diffusion is performed or the time during which air diffusion and the preliminary filtration operation at a flux set to a value of 40% or less of the flux during the normal filtration operation are performed is determined on the basis of the characteristic of the activated sludge solution. This is because, after the characteristic of the activated sludge solution satisfies a preset criterion (the absolute value or prediction from a change rate or change behavior), the preparatory operation by the second preliminary filtration operation at a flux set to a value of 50% to 80% of the flux during the normal filtration operation, or the normal filtration operation is resumed, so that the operating conditions can be changed more accurately while the burden on the membrane is maintained to the minimum.

The activated sludge whose characteristic is to be evaluated is preferably sludge collected from the vicinity of the membrane module. However, when sludge in another section in the membrane separation activated sludge tank or in a tank independent of the membrane separation activated sludge tank is mixed, the sludge collected from any point may be monitored as long as the time required to move back and forth with the sludge in the vicinity of the membrane module is considered and the sampling point is the same. Here, in order to clarify the position in the vicinity of the membrane module, for the sake of convenience in the present invention, the vicinity of the membrane module is defined as a range located within a distance of 1 m from a member constituting an arbitrary membrane module, and sludge existing between membranes of the membrane module, sludge located within 1 m in the vertical direction of the membrane module, and the like correspond thereto.

Here, examples of the characteristic of the activated sludge solution serving as the basis for changing the operating conditions after the chemical cleaning include the viscosity of the activated sludge solution, the amount of the filter paper filtrate, the turbidity of the filter paper filtrate, the capillary suction time (CST), the image information from the microscope, the oxygen consumption rate, the foaming power, the membrane filtration resistance, the organic substance concentration in the centrifugal supernatant of the activated sludge solution (examples of the method for measuring the organic substance concentration include the total organic carbon (TOC) concentration, the chemical oxygen demand (COD) concentration, and the biological oxygen demand (BOD) concentration), the organic substance concentration in the filter paper filtrate of the activated sludge solution, the organic substance concentration in the membrane filtrate of the activated sludge solution, the sludge volume index (SVI), the sludge volume (SV) of the activated sludge solution or the diluted solution thereof with treated water, and the adenosine triphosphate (ATP) concentration.

As a result of intensive studies by the present inventors, it has been found that the turbidity of the filter paper filtrate of the activated sludge solution, image information from a microscope, the membrane filtration resistance (calculated from a result of a membrane filtration test using a membrane piece), the TOC concentration in the filter paper filtrate, and the TOC concentration in the membrane filtrate are particularly effective as indices for determining the membrane filtration characteristic of the activated sludge solution after chemical cleaning, from the viewpoints of measurement accuracy, measurement time, reliability, and convenience.

Here, the turbidity represents the degree of turbidness of water, and the turbidity corresponding to turbidness of 1 mg/L of formazine contained in 1 L of water is represented as 1 NTU (nephelometric turbidity unit). The turbidity of the filter paper filtrate of the activated sludge solution refers to the turbidity of the filtrate obtained by filtering a predetermined amount of activated sludge with filter paper, and the evaluation method is not particularly limited. The turbidity of the filtrate obtained by filtering 50 ml of the activated sludge solution using filter paper corresponding to JIS P 3801, Filter paper for Chemical Analysis, 5C (particle retention capacity: 1 μm) can be exemplified as a suitable index.

When this evaluation method is applied to the sludge in the vicinity of the membrane module before the chemical cleaning, for example, the turbidity of the filtrate is about 3 NTU, but after the chemical cleaning, components derived from the sludge damaged by the chemical solution are released into the activated sludge solution, so that the turbidity of the filter paper filtrate of the sludge in the vicinity of the membrane module temporarily increases to a value such as about 15 NTU due to the turbidness.

When the method of the present invention is used, during the operation after the chemical cleaning, the behavior of the improvement in sludge filtration characteristics due to the dilution effect of the turbidity component due to the mixing of the activated sludge solution, the adsorption, decomposition, and aggregation effect of the turbidity component by the activated sludge, and the like can be observed from the behavior of the reduction in turbidity of the filter paper filtrate. In the resumption of the operation after the chemical cleaning, the normal filtration operation is resumed after the activated sludge solution is recovered on the basis of a criterion corresponding to the plant. Before resuming the filtration operation, the preparatory operation at a flux set to a value of 50% to 80% of the flux during the normal filtration operation may be performed.

By setting the criterion of the turbidity of the filter paper filtrate, the time during which only air diffusion or air diffusion together with the filtration operation at a flux set to a value of 40% or less of the flux during the normal filtration operation is performed, and the time during which the preliminary operation of the second preliminary filtration operation is continued at a flux set to a value of 50% to 80% of the flux during the normal filtration operation can each be reasonably determined on the basis of the turbidity value of the filter paper filtrate of sludge, so that the operation can be efficiently returned to the normal operation, and the operation stability after the normal operation is resumed is improved.

The turbidity of the filter paper filtrate contains information reflecting the abundance of biopolymers such as proteins and polysaccharides that are generated by damage caused by the chemical solution and have a size equal to or smaller than the pore size (1 μm) of the filter paper. These components are substances that easily foul a membrane having a pore size of 0.01 μm or more and less than 1 μm used in the membrane separation activated sludge method. That is, the turbidity of the filter paper filtrate of sludge is easy to measure and can be used as a determination index of filtration characteristics of sludge with high accuracy and reliability, so that the turbidity can be mentioned as a particularly preferable characteristic to be used when operating conditions are changed after chemical cleaning.

The image information from the microscope is information such as a total area in the field occupied by objects other than water, such as flocs of activated sludge, broken (micronized) flocs, and floating particles observed in the field when the activated sludge solution is observed with an optical microscope at a magnification of 100 to 400 (when observed through an eyepiece), a total length of boundary lines between the objects other than water and water in the field, and the like. These pieces of analysis information are correlated with the turbidity and membrane filtration resistance of the filter paper filtrate of the activated sludge solution and have an advantage that information on the activity of microorganisms such as animalcules can also be obtained. In addition, by combining and utilizing a system that automatically supplies sludge to the microscopic field at a constant frequency and an image analysis system, it is easy to acquire data in an unmanned and continuous manner. Therefore, a control system that continuously measures image information on the activated sludge solution from the microscope after chemical cleaning and automatically returns the membrane-separation activated sludge treatment device to the normal filtration operation after the measurement result satisfies a preset criterion (absolute value or change rate) may be provided.

When the concentration is too high for acquiring image information of activated sludge, sludge flocs occupy almost the entire field, making it difficult to observe broken (micronized) flocs and particles floating in water. Therefore, the MLSS concentration at the time of observation is preferably 10,000 mg/L or less, more preferably 8,000 mg/L or less. When the sludge is diluted, it is best to use the filtered water through the membrane module of the membrane separation activated sludge method treatment device from the viewpoint that floating particles affecting the observation are substantially absent, and the microorganisms in the sludge do not cause shock rupture due to a change in osmotic pressure because the osmotic pressure is the same as that of the activated sludge solution.

The membrane filtration resistance of the activated sludge solution is a filtration resistance calculated from data obtained when the activated sludge solution is filtered under predetermined conditions using a microfiltration membrane or an ultrafiltration membrane, and the evaluation method is not particularly limited. The membrane filtration resistance can be calculated from data obtained by measuring the amount of filtrate over time when a membrane piece is loaded in a small cell filtration test device, an activated sludge sample is poured, and filtration is performed under a constant pressure or constant flow rate condition. Here, as the membrane, it is preferable to use a membrane having a pore size of 0.01 μm or more and less than 1 μm, and it is particularly preferable to use a membrane having the same specification as that used for the membrane separation module since the reliability of monitoring can be enhanced.

The TOC concentration in the filter paper filtrate of the activated sludge solution and the TOC concentration in the membrane filtrate can be measured by injecting filtered water obtained by filtering the activated sludge solution by the filter paper filtration method or the membrane filtration method described above into a TOC analyzer, and the specifications and the like of the analyzer to be used are not particularly limited. Since the membrane filtrate is a liquid already subjected to membrane filtration, the liquid contains almost no substances that cause filtration resistance of the membrane. However, damage to sludge caused by the chemical solution occurs simultaneously on various scales, from an increase in the concentration of soluble organic substances equal to or smaller than the pore size of the membrane to an increase in broken flocs of the sludge. Therefore, information on the increase or decrease in membrane filtration resistant substances of sludge generated in conjunction can also be inferred from the TOC measurement result of the membrane filtrate.

As another method for measuring the concentration of organic substances contained in the filter paper filtrate or the membrane-filtered water, there are COD, BOD, and the like, but the measurement takes time. There is also a method of measuring COD, BOD, and the like with a simple kit, but since it is colorimetric evaluation using a coloring reagent, the accuracy of quantification is low. For the evaluation of the characteristic of the activated sludge solution of the present invention, the TOC concentration in the filter paper filtrate and the TOC concentration in the membrane filtrate are preferably used.

The TOC analyzer used for the measurement is particularly preferable because a scientifically accurate value can be measured in a short time (typically within a few minutes from injection into the analyzer). When the TOC concentration in the membrane filtrate of the activated sludge solution is used as an index, the membrane filtrate of the activated sludge solution can be substituted with the treated water of the membrane module during normal operation before chemical cleaning or during filtration after chemical cleaning. In this case, it is particularly preferable to use a TOC analyzer (such as TNC-200S manufactured by Toray Engineering D Solutions Co., Ltd.) capable of continuously or intermittently automatically measuring the TOC concentration because the characteristics of the activated sludge before and after the chemical cleaning can be stably measured.

When the normal filtration operation is resumed or when the filtration operation is changed to the filtration operation at a flux set to a value of 50% to 80% of the flux during the normal filtration operation, the determination criterion for the characteristic of the activated sludge solution varies depending on the type of wastewater and the value of the flux during the filtration operation designed for each plant. Therefore, it is desirable to establish conditions and set the determination criterion for each plant site. Specifically, these criteria values may be established on site on the basis of the results of initial chemical cleaning after the start of operation and can be set by evaluating the filtration characteristics of sludge before and after chemical cleaning over time when chemical cleaning is performed, starting the filtration operation at the flux during the normal filtration operation or a flux of 50% to 80% thereof at different timings between a plurality of membrane module systems, and efficiently specifying the criterion on the basis of the transition of the differential pressure in the respective lines after the filtration operation. In addition, the same wastewater as that of the actual device may be treated using a small membrane separator loaded with a plurality of membrane modules that can be independently evaluated, and the same test may be performed. The small membrane separator has, for example, a capacity of about 30 L.

As described above, it is preferable to verify and maintain the characteristics of the activated sludge solution and the determination criteria thereof at the time of operation change on site. However, in a sewage treatment plant having a flux of 0.5 to 0.7 m³/m²·d during normal filtration operation, when it is not possible to afford to conduct a test or the like, examples of suitable criteria for resuming the normal filtration operation include satisfaction of “the value of the turbidity of the filter paper filtrate≤the value of the turbidity of the filter paper filtrate before cleaning+4” (unit: NTU) in the case of the turbidity of the filter paper filtrate of the activated sludge solution, satisfaction of “the sum of the areas of the flocs with an area of 200 μm² or less/the value of the area of the microscopic field≤(the sum of the areas of the flocs with an area of 200 μm² or less before chemical cleaning/the value of the area of the microscopic field)×1.3” in the case of the image information from the microscope, and satisfaction of “the value of the increase in membrane filtration resistance≤the value of the increase in membrane filtration resistance before cleaning×2.5” in the case of the membrane filtration resistance calculated from the result of the membrane filtration test using a membrane piece. The same effect can be obtained by using any of the indices of the turbidity of the filter paper filtrate of the activated sludge solution, the image information from the microscope, and the membrane filtration resistance.

Among the characteristics of the activated sludge solution, in particular, the turbidity of the filter paper filtrate of the activated sludge solution is easily measured and highly accurate. Therefore, when this index is used, it is possible to monitor the sludge more finely and change the operating conditions. After chemical cleaning of the membrane is completed, air diffusion is resumed, or filtration operation is resumed at a flux set to a value of 40% or less of the flux during the normal filtration operation simultaneously with resumption of the air diffusion, the filtration operation is then changed to the second preliminary filtration operation at a flux set to a value of 50% to 80% of the flux during the normal filtration operation after the characteristic of the activated sludge solution satisfies the preset second criterion, and the normal filtration operation can be resumed after the characteristic of the activated sludge solution satisfies the preset first criterion.

As described above, it is preferable to verify and maintain the characteristics of the activated sludge solution and the determination criteria thereof at the time of operation change on site. As a standard, in the case of a sewage treatment plant having a flux of 0.5 to 0.7 m³/m²·d during normal filtration operation, as a second criterion, “the value of the turbidity of the filter paper filtrate≤the value of the turbidity of the filter paper filtrate before chemical cleaning+8” (unit: NTU) can be mentioned as a suitable criterion, and as the first criterion, “the value of the turbidity of the filter paper filtrate<the value of the turbidity of the filter paper filtrate before chemical cleaning+4” (unit: NTU) can be mentioned as a suitable criterion.

The measurement of the characteristics of the activated sludge solution before and after the chemical cleaning and the resumption of the normal filtration operation on the basis of the characteristic measurement result may be performed on site. Alternatively, information obtained by measuring the characteristic of the activated sludge solution before and after the chemical cleaning may be judged by judging means provided at a remote location connected by a communication device, a control condition related to resumption of the normal filtration operation may be output when a judgment result satisfies a preset criterion, and the normal filtration operation may be resumed according to the output control condition.

In addition, the operation may be automatically performed using a management program by causing a computer to run as means for collecting activated sludge, means for measuring the characteristic of the collected activated sludge solution, means for making a judgement on the basis of a result of measuring the characteristic of the activated sludge solution, means for outputting an operation control condition on the basis of a judgement result, and means for resuming the normal filtration operation in accordance with the output control condition.

The membrane-separation activated sludge treatment device according to the present invention includes a data storage unit configured to store information on measurement of the characteristic of the activated sludge solution before and after the chemical cleaning from after the normal filtration operation is performed until the normal filtration operation is resumed after the chemical cleaning of the separation membrane in the membrane module, a communication device configured to transmit the information to a remote location, and a controller configured to control resumption of the normal filtration operation on the basis of the characteristic of the activated sludge solution before and after the chemical cleaning. The controller is a series of management programs that perform as the means for collecting the activated sludge solution, the means for measuring the characteristic of the collected activated sludge solution, the means for making a judgement on the basis of a result of measuring the characteristic of the activated sludge solution, the means for outputting an operation control condition on the basis of a judgement result, and the means for resuming the normal filtration operation in accordance with the output control condition. A part of the management program can be executed via judging means provided at a remote location, and it is a membrane-separation activated sludge treatment device capable of appropriately controlling resumption of operation.

### EXAMPLES

The present invention will be described concretely hereinafter with reference to examples and comparative examples. However, the present invention is not limited to the examples at all. Hereinafter, a method for measuring the characteristic derived from the fouling material in the activated sludge solution will be described.

### Measurement of Turbidity of Filter Paper Filtrate of Activated Sludge Solution

The turbidity of the filter paper filtrate of the activated sludge solution is measured as follows. From the vicinity of the separation membrane, 50 ml of the activated sludge solution is collected. When the activated sludge solution is filtered using 5C (pore size: 1 μm) filter paper (manufactured by Advantec Co., Ltd.), the turbidity of the filter paper filtrate collected in 5 minutes is measured using a portable turbidimeter (2100Q manufactured by Hach Company). The turbidity is measured using a filtrate collected in 5 minutes but is not particularly limited as long as the amount of the filtrate is enough for measuring the turbidity.

The calibration curve for the turbidity is prepared using a formazine standard solution (such as StablCAL standard solution kit for 2100Q manufactured by Hach Company, manufactured by Hach Company) commercially available from a manufacturer. When the amount of the filter paper filtrate obtained in 5 minutes was less than 15 mL required for measurement with a portable turbidimeter, filtration was continued as it was to secure the amount required for measurement of the turbidity. The measurement is performed at a liquid temperature of 25° C.

### Measurement of Image Information from Microscope Showing Floc Region

The image information from the microscope showing the floc region of the activated sludge solution is measured as follows. An activated sludge solution was collected from the vicinity of the separation membrane, 5 microliters of the activated sludge solution was placed on a slide glass, the sample was covered with a cover glass, the prepared slide was fixed on a stage of a biological microscope CX41LF manufactured by Olympus Corporation, and an image was acquired by a camera using a 10× objective lens. Flocs each having an area of 200 μm² or less are automatically discriminated, a photographed image is analyzed using image analysis software produced specifically and capable of calculating the total area, and the total [μm^{2]} of the areas of the flocs each having an area of 200 μm² or less with respect to the area [μm²] of the microscopic field is calculated.

### Measurement of Membrane Filtration Resistance

The membrane filtration resistance of the activated sludge solution is evaluated as follows. From the vicinity of the separation membrane, about 1 L of the activated sludge solution is collected. A new flat membrane piece (manufactured by Toray Industries, Inc.) made of polyvinylidene fluoride having a pore size of 0.08 μm was fixed to a container using Amicon Stirred Cell UFSC05001 manufactured by Millipore Corporation. Thereafter, 50 ml of the activated sludge solution was put in the container, suction filtration was performed at a flux (: J) of 3 m³/m²/d with a metering pump under the condition of being stirred at 450 rpm, and the membrane filtrate was circulated to the cell. On the basis of the filtration time and the suction pressure (using a low pressure sensor capable of measurement from 0 to −25 kPa, manufactured by Valcom Co., Ltd.) recorded with a data logger, a transmembrane pressure difference: P at each time is acquired. Since the viscosity: μ of the membrane-filtered water was substantially equal to the viscosity of water, the viscosity was approximated by the viscosity of water, and the viscosity of water was calculated by inputting the temperature of the activated sludge solution in a temperature-dependent expression of the viscosity of water. The membrane filtration resistance: R at each time is calculated from the relationship of P/(μ×J), and the degree of increase in membrane filtration resistance is calculated from the relationship between the cumulative amount of filtered water per unit membrane area and the filtration resistance at that time point.

### Method for Measuring TOC Concentration in Filter Paper Filtrate and TOC Concentration in Membrane Filtrate

The TOC concentration in the filter paper filtrate of the activated sludge solution and the TOC concentration in the membrane filtrate are measured as follows. From the vicinity of the separation membrane, about 1 L of the activated sludge solution is collected. The filter paper filtrate of the sludge solution was obtained by filtering the activated sludge solution with 5C (pore size: 1 μm) filter paper (manufactured by Advantec Co., Ltd.). A new flat membrane piece (manufactured by Toray Industries, Inc.) made of polyvinylidene fluoride having a pore size of 0.08 μm was fixed to Amicon Stirred Cell UFSC05001 manufactured by Millipore Corporation, 50 ml of the activated sludge solution was put in the container, and suction filtration was performed at a flux (: J) of 3 m³/m²/d with a metering pump under the condition of being stirred at 450 rpm to obtain the membrane filtrate. The TOC concentration is measured using a TOC analyzer TOC-L manufactured by Shimadzu Corporation. As the filter paper used for filtration, it is preferable to use the membrane installed in the membrane module from the viewpoint of easily reflecting the situation in an actual device.

### Example 1

A test was performed in a wastewater treatment facility having the configuration shown in FIG. 1. The sludge concentration was controlled so that the activated sludge mixed liquor (MLSS) concentration was about 8,000 mg/L in the activated sludge tank equipped with the membrane module (flat membrane module was used), and the membrane module was subjected to intermittent filtration operation (filtration for 9 minutes and interruption of filtration for 1 minute) at an average flux of 0.7 m/d while membrane surface air diffusion was performed at a required air volume from a fine bubble diffuser tube.

After the start of the operation, the filtration differential pressure (at the time of filtration−at the time of filtration interruption) reached the timing of performing chemical cleaning (increase by 5 kPa from the initial stage of the operation at the same flux). The device was stopped including filtration and air diffusion from the diffuser means, and chemical cleaning was performed while the membrane module was immersed in the activated sludge tank.

As the chemical solution, an aqueous sodium hypochlorite solution having an effective chlorine concentration of 5,000 mg/L was used and injected into the membrane module from an injection port of a filtered water pipe of the flat membrane module such that an amount a little larger than the half of the injected solution permeated from the inside to the outside of the flat membrane, and this state was maintained for about 100 minutes to perform chemical cleaning.

In this test plant, attention was paid to the turbidity of the filter paper filtrate of the activated sludge solution as the characteristic of the activated sludge solution, and the normal operation was not resumed immediately after the completion of the chemical cleaning of the membrane. First, preliminary operation of resuming air diffusion interrupted during chemical cleaning of the membrane was performed, and the filtration operation was resumed after the first criterion was satisfied. In Example 1, until the turbidity of the filter paper filtrate of the activated sludge solution in the vicinity of the membrane module in the membrane-separation activated sludge tank became equal to or less than a value obtained by adding 4.0 to the measured value of the turbidity of the filter paper filtrate of the activated sludge solution in the vicinity of the membrane module in the membrane-separation activated sludge tank measured before injecting the chemical solution on the day of chemical cleaning, air was diffused from the diffuser tube installed below the membrane module without performing filtration, and at the same time, the operation of the auxiliary diffuser tube 3, a stirrer 6 of an anoxic tank 5, and a pump 12 for returning the activated sludge solution from the activated sludge tank 4 to the anoxic tank 5 was resumed to mix the sludge. After the chemical cleaning, the state of the activated sludge was evaluated by a method for measuring the turbidity of the filter paper filtrate of the activated sludge solution for each elapsed time from the start of membrane surface air diffusion.

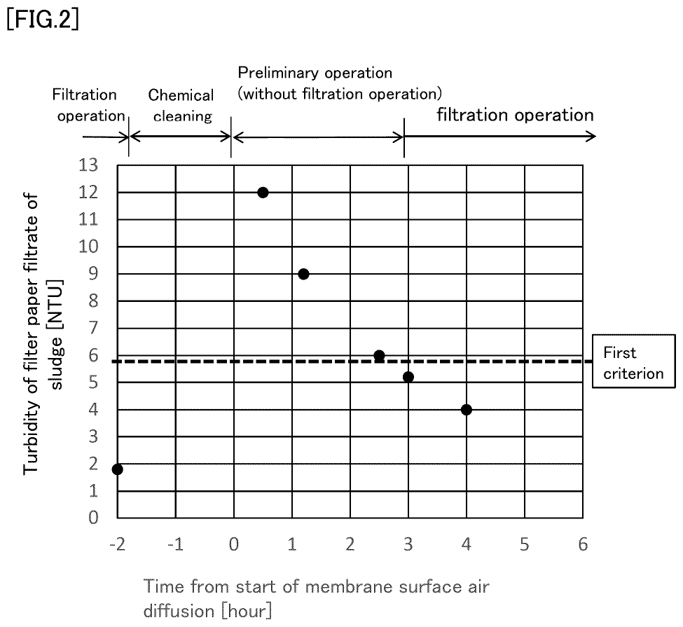

FIG. 2 shows a change in turbidity [NTU] of the filter paper filtrate of the sludge in the aspect of Example 1. The turbidity value of the filter paper filtrate of the activated sludge solution measured before the chemical cleaning (before the start of injection of the chemical solution) on the day of the chemical cleaning was 1.8 NTU. In view of the results, the first criterion was set to a turbidity of the filter paper filtrate of the activated sludge solution in the vicinity of the membrane module in the membrane-separation activated sludge tank of 1.8+4.0=5.8 [NTU]. Therefore, the normal operation (filtration operation at an average flux of 0.7 m/d) was resumed at 5.8 [NTU] or less, and the operation method of the membrane of the membrane-separation activated sludge treatment device after chemical cleaning was managed.

As shown in FIG. 2, the activated sludge solution in the vicinity of the membrane module of the activated sludge tank was periodically collected, and the temporal change in turbidity of the filter paper filtrate of the activated sludge solution was evaluated. As a result, the turbidity of the filter paper filtrate of the activated sludge solution reached 5.2 NTU at about 3 hours after the start of the sludge mixing, and the criterion for resuming the normal operation (5.8 NTU or less) was met. Thus, the normal operation was resumed. As a result, even when 30 days have elapsed since the normal operation was resumed, the filtration differential pressure did not reach the timing of performing the chemical cleaning, and stable operation could be continued for a long period of time.

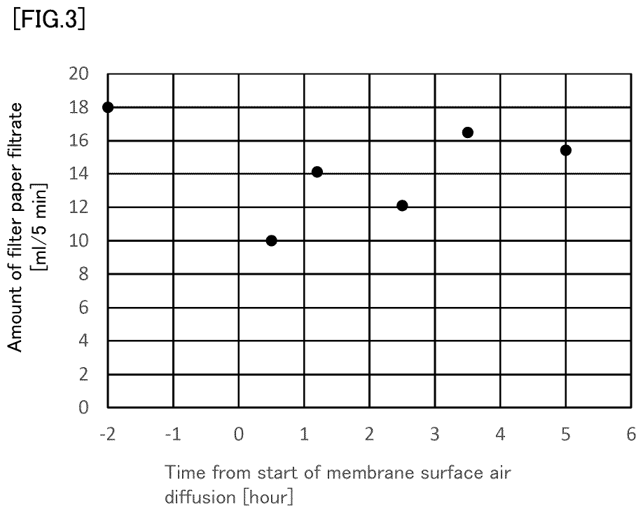

FIG. 3 shows the results of evaluation performed using the amount of the filter paper filtrate of the activated sludge solution, which is most common, as the characteristic of the activated sludge solution in the membrane separation activated sludge method. The evaluation results of the amount of the filter paper filtrate of the activated sludge solution also gave information on the membrane filtration characteristics of the activated sludge solution. However, it was found that, due to the large variation in the values, more accurate information on the temporal change in the membrane filtration characteristics can be obtained by focusing on the turbidity of the filter paper filtrate of the activated sludge solution.

### Comparative Example 1

After the filtration operation was performed under the same conditions in the same facility as in Example 1, mixing of sludge was resumed immediately after chemical cleaning was performed under the same conditions as in Example 1 at the timing of chemical cleaning. No preliminary operation was performed. The first criterion was 5.8 [NTU], but after 10 minutes, when the turbidity value of the filter paper filtrate of the activated sludge solution was 12.8 [NTU], the membrane surface air diffusion of the membrane module was resumed, and the filtration operation at an average flux of 0.7 m/d was resumed. At the same time, the pump 12 was operated to return sludge, and the stirring 6 in the anoxic tank 5 and the air diffusion from the auxiliary diffuser tube 3 installed in the same tank as the membrane-separation activated sludge tank were resumed to resume the wastewater treatment. After the operation was resumed, the membrane began to be clogged rapidly, and the filtration differential pressure reached the timing of performing the chemical cleaning at the time when about 16 hours had elapsed after the operation was resumed.

### Comparative Example 2

After the filtration operation was performed under the same conditions in the same facility as in Example 1, mixing of sludge was resumed immediately after chemical cleaning was performed under the same conditions as in Example 1 at the timing of chemical cleaning. No preliminary operation was performed. The first criterion was 5.8 [NTU], but when the turbidity value of the filter paper filtrate of the activated sludge solution reached 9.5 [NTU] after about 1 hour, the filtration operation at an average flux of 0.7 m/d was resumed. When the operation was resumed and about one day had elapsed, the filtration differential pressure reached the timing of performing the chemical cleaning.

### Comparative Example 3

After the filtration operation was performed under the same conditions in the same facility as in Example 1, after chemical cleaning was performed under the same conditions as in Example 1 at the timing of chemical cleaning, mixing of sludge was resumed, and the filtration operation was resumed at an average flux of 0.2 m/d (29%). Preliminary operation involving membrane surface air diffusion was not performed. The first criterion was 5.8 [NTU], but when the turbidity value of the filter paper filtrate of the activated sludge solution reached 6.4 [NTU] after about 2.5 hours, the filtration flux was changed from an average flux of 0.2 m/d to an average flux of 0.7 m/d, and the normal operation was resumed. The filtration differential pressure slightly increased immediately after the start of filtration at an average flux of 0.7 m/d, and its influence lasted to cause the filtration differential pressure to reach the timing of performing the chemical cleaning at the time when 5 days had passed after the resumption of the normal operation.

### Example 2

An auxiliary diffuser tube (fine bubbles) and a diffuser tube (coarse bubbles) for a membrane module were installed in a single water tank, a membrane module was installed above the diffuser tube for a membrane module, and wastewater was treated. As the membrane module, a membrane-separation activated sludge treatment device manufactured by Toray Industries, Inc. was used. The sludge concentration was controlled so that the activated sludge mixed liquor (MLSS) concentration was about 10,000 mg/L in the tank, and filtration operation at an average flux of 0.6 m/d was performed while membrane surface air diffusion was performed at a required air volume from the diffuser tube for a membrane module. Air was diffused from the auxiliary diffuser tube as necessary so that the value of the dissolved oxygen concentration in the tank was 1 mg/L or more. When the filtration differential pressure (at the time of filtration−at the time of filtration interruption) reached the timing of performing chemical cleaning (increase by 5 kPa from the initial stage of operation at the same flux), the device was stopped including the membrane filtration and the air diffusion from the auxiliary diffuser tube and the diffuser tube for a membrane module.

Chemical cleaning was performed with the membrane module immersed in the activated sludge tank. As the chemical solution, an aqueous sodium hypochlorite solution having a concentration of 3,000 mg/L was used and injected into the membrane module from an injection port of a filtered water pipe of the flat membrane module such that the half of the injected solution permeated from the inside to the outside of the flat membrane, and this state was maintained for about 90 minutes to perform chemical cleaning.

In Example 2, focusing on the membrane filtration resistance as the characteristic of the activated sludge solution, a membrane filtration test was performed using the activated sludge solution in the membrane separation tank after completion of the chemical cleaning. Preliminary operation was performed until the value of the degree of increase in membrane filtration resistance (filtration resistance/amount of filtered water per unit membrane area) was less than 2.5 times the value of the degree of increase in membrane filtration resistance measured before the chemical cleaning. Without performing filtration or supply of wastewater, preliminary operation was performed mainly for mixing sludge by diffusing air from the diffuser tube for a membrane module and the auxiliary diffuser tube, and the normal operation (filtration operation at an average flux of 0.6 m/d) was resumed after it was found that the value of the increase in membrane filtration resistance was less than 2.5 times the value of the increase in membrane filtration resistance measured before the chemical cleaning.

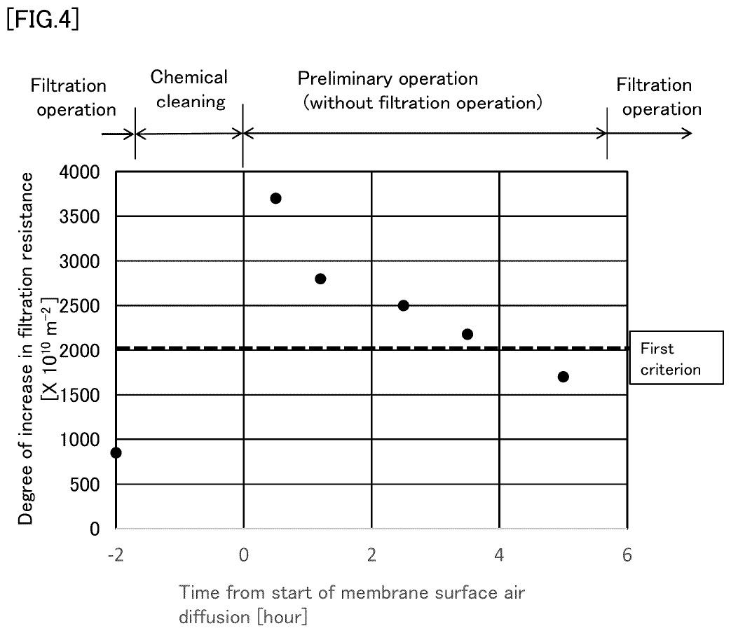

FIG. 4 shows an example of the degree of increase in membrane filtration resistance of the activated sludge solution after the chemical cleaning and during the preliminary operation. Immediately after the chemical cleaning, the degree of increase in filtration resistance was 3,700 [×10¹⁰ m²]. The preliminary operation was performed, and the characteristic of the activated sludge solution collected from the vicinity of the membrane was evaluated at each elapsed time after the membrane surface air diffusion was resumed to manage the operation after the chemical cleaning. The value of the degree of increase in membrane filtration resistance measured for the sludge collected before the chemical cleaning was 850 [×10¹⁰ m^{-2].} After the chemical cleaning, a value of the degree of increase in membrane filtration resistance of 850×2.5=2,125 was set to the first criterion, and after the value was reduced to less than 2,000 [×10¹⁰ m⁻²] on the safe side, filtration was resumed.

As the value increased after the chemical cleaning, the degree of increase in membrane filtration resistance of the sludge collected at the point of time when about 5 hours had elapsed after the completion of the chemical cleaning was 1,700 [×10¹⁰ m⁻²] due to the preliminary operation mainly aimed at mixing the sludge by performing air diffusion from the diffuser tube for a membrane module and the auxiliary diffuser tube without performing filtration or supply of wastewater. After it was confirmed that the first criterion was satisfied, the normal operation was resumed. Even when two months have elapsed since the operation was resumed, the filtration differential pressure did not reach the timing of performing the chemical cleaning, and stable operation could be continued.

### Example 3

An auxiliary diffuser tube (fine bubbles) and a diffuser tube (coarse bubbles) for a membrane module were installed in a single water tank, a membrane module was installed above the diffuser tube for a membrane module, and wastewater was treated. The sludge concentration was controlled so that the activated sludge mixed liquor (MLSS) concentration was about 8,000 mg/L in the tank, and intermittent filtration operation at an average flux of 0.6 m/d was performed while membrane surface air diffusion was performed at a required air volume from the diffuser tube for a membrane module. Air was diffused from the auxiliary diffuser tube as necessary so that the value of the dissolved oxygen concentration in the tank was 1 mg/L or more. When the filtration differential pressure (at the time of filtration−at the time of filtration interruption) reached the timing of performing chemical cleaning (increase by 5 kPa from the initial stage of operation at the same flux), the device was stopped including the membrane filtration and the air diffusion from the auxiliary diffuser tube and the diffuser tube for a membrane module.

Chemical cleaning was performed with the membrane module immersed in the activated sludge tank. As the chemical solution, an aqueous sodium hypochlorite solution having a concentration of 3,000 mg/L was used and injected into the membrane module from an injection port of a filtered water pipe of the flat membrane module such that an amount a little larger than the half of the injected solution permeated from the inside to the outside of the flat membrane, and this state was maintained for about 60 minutes to perform chemical cleaning.

In Example 3, after completion of the chemical cleaning, image information from a microscope was analyzed using the activated sludge solution in the membrane separation tank to monitor the state of the activated sludge solution. As the first criterion, a ratio of the total area of flocs with an area of 200 μm² or less to the area of the microscopic field (the total area of the flocs with an area of 200 μm² or less in the microscopic field÷the total area of the microscopic field) of 1.3 times the value before the chemical cleaning was applied. The sludge was mixed by starting air diffusion from the diffuser tube for a membrane module and the auxiliary diffuser tube without performing filtration or supply of wastewater until the area ratio of the flocs was equal to or less than the first criterion. After confirming that the ratio of the flocs with an area of 200 μm² or less in the microscopic field fell below the first criterion, the normal operation (filtration operation at an average flux of 0.6 m/d) was resumed. Specifically, since the value before the chemical cleaning was 1.6%, the first criterion was set to 2.1%, and the normal operation was resumed after 2.1% or less was satisfied.

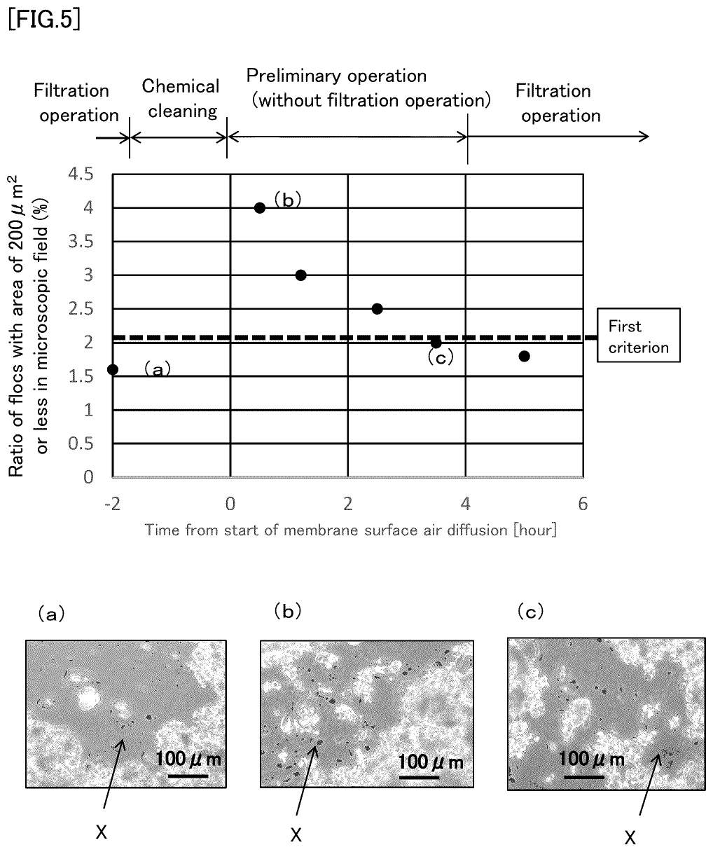

FIG. 5 shows the relationship between the time from the start of membrane surface air diffusion after chemical cleaning and the ratio (%) of flocs. FIG. 5 illustrates image information from the microscope at each of times (a), (b), and (c). At the time (b) after the chemical cleaning, it is found that black fluxes X increased and the ratio of flocs was as high as 4%. The operation after the chemical cleaning was suitably managed on the basis of the image information from the microscope as the evaluation characteristic of the activated sludge solution. By continuing practice of performing the preliminary operation after the chemical cleaning and resuming the filtration operation after the first criterion was satisfied, it was made possible to continuously avoid a situation in which chemical cleaning was required again in a short period of time when the normal operation was resumed after the chemical cleaning.

### Example 4

A test was performed in a wastewater treatment facility having the configuration shown in FIG. 1. The sludge concentration was controlled so that the activated sludge mixed liquor (MLSS) concentration was about 8,000 mg/L in the activated sludge tank equipped with the membrane module (flat membrane module was used), and the membrane module was subjected to intermittent filtration operation at an average flux of 0.7 m/d while membrane surface air diffusion was performed at a required air volume from a coarse bubble diffuser tube. After the operation was started, when the filtration differential pressure (at the time of filtration -at the time of filtration interruption) reached the timing of performing chemical cleaning (increase by 5 kPa from the initial stage of operation at the same flux), the device was stopped including the air diffusion from the diffuser means.

Chemical cleaning was performed with the membrane module immersed in the activated sludge tank. As the chemical solution, an aqueous sodium hypochlorite solution having a concentration of 5,000 mg/L was used and injected into the membrane module from an injection port of a filtered water pipe of the flat membrane module such that a portion of the injected solution permeated from the inside to the outside of the flat membrane, and this state was maintained for about 2 hours to perform chemical cleaning. In Example 4, attention was paid to the turbidity of the filter paper filtrate of the activated sludge solution. First, in a state where filtration was interrupted after the chemical cleaning, preliminary operation of only membrane surface air diffusion from the diffuser means disposed below the membrane module was performed. Since the turbidity measured before injecting the chemical solution on the day of chemical cleaning was 2 [NTU], after it was confirmed that the turbidity reached, as the second criterion, a value equal to or less than a value obtained by adding 8, the preparatory operation of performing the second preliminary filtration operation at an average flux of 0.4 m/d (corresponding to 66% of the flux during the normal operation), which corresponds to 50% to 80% of the flux during the normal filtration operation, was started. The turbidity value measured before injecting the chemical solution on the day of chemical cleaning was 2 [NTU], and the normal operation was resumed after it was confirmed that the turbidity value was equal to or less than the first criterion obtained by adding 4. For the first criterion and the second criterion, predetermined values appropriate for recovery of the activated sludge solution were set.

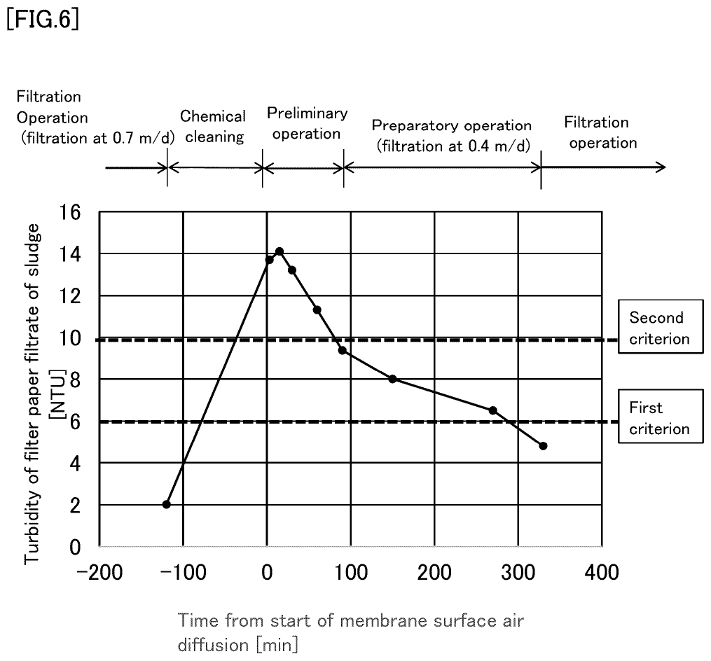

FIG. 6 shows the relationship between the turbidity of the filter paper filtrate of the activated sludge solution in the vicinity of the membrane module of the membrane-separation activated sludge tank and the time from the start of membrane surface air diffusion after chemical cleaning. In Example 4, since it was the timing to perform chemical cleaning, chemical cleaning was performed under the above-described conditions, the membrane surface air diffusion from the diffuser means disposed below the membrane module and return of sludge by operating the pump 12 were then performed in a state where the filtration was interrupted, and the stirring 6 of the anoxic tank 5 and the air diffusion from the auxiliary diffuser tube 3 installed in the same tank as the membrane-separation activated sludge tank were resumed. The turbidity value of the filter paper filtrate of the activated sludge solution measured before the chemical cleaning on the day of the chemical cleaning was 2 NTU. Therefore, the method for operating the membrane-separation activated sludge treatment device after chemical cleaning of the membrane was managed in such a manner that a turbidity of the filter paper filtrate of the activated sludge solution in the vicinity of the membrane module of the membrane-separation activated sludge tank of 10 NTU or less was set to the second criterion, filtration at an average flux of 0.4 m/d, which corresponds to a flux of 50% to 80% of the flux during the normal filtration operation, was started after the second criterion was satisfied, a turbidity of the filter paper filtrate of the activated sludge solution in the vicinity of the membrane module of the membrane-separation activated sludge tank of 6 NTU or less was set to the first criterion, and the normal operation (filtration operation at an average flux of 0.7 m/d) was resumed after the first criterion was satisfied.

The activated sludge solution in the vicinity of the membrane module of the activated sludge tank was periodically collected, and the result of evaluation of the temporal change in turbidity of the filter paper filtrate of the activated sludge solution is shown. The turbidity of the filter paper filtrate of the activated sludge solution reached 9.4 NTU at about 90 minutes after the start of the sludge mixing, and the second criterion (10 NTU or less) was met. Thus, intermittent filtration was started at an average flux of 0.4 m/d, which corresponds to 50% to 80% of the flux during the normal filtration operation. Further, when about 4 hours had elapsed, the turbidity of the filter paper filtrate of the activated sludge solution was 4.7 NTU, which satisfied the first criterion, and thus the normal operation was resumed. As a result, even when 30 days have elapsed since the normal operation was resumed, the filtration differential pressure did not reach the timing of performing the chemical cleaning, and it was confirmed that stable operation could be continued.

### DESCRIPTION OF REFERENCE SIGNS

1: Membrane module
2: Diffuser tube for membrane module
3: Auxiliary diffuser tube
4: Activated sludge tank
5: Treatment tank (such as anoxic tank) other than activated sludge tank in which membrane module is to be immersed
6: Stirrer
7: Chemical solution tank
8: Supply line of water to be treated
9: Permeated water discharge line
10: Sludge return line
11: Sludge discharge line
12: Pump
13: Air supply device for auxiliary diffuser tube
14: Air supply device for diffuser tube for membrane module
15: Sludge supply line
S: Bubble
X: Floc region having area of 200 μm² or less

1. A method for operating a membrane-separation activated sludge treatment device including an activated sludge tank configured to treat water to be treated with activated sludge; a membrane module immersed in the activated sludge tank; diffuser means disposed below the membrane module; and permeated water discharge means configured to discharge permeated water having permeated through the membrane module to outside of the device, the method comprising:
interrupting filtration operation after filtration operation is performed;
injecting a chemical solution for cleaning from a permeated water discharge side of the membrane module with the membrane module immersed in the activated sludge tank to perform chemical cleaning of a separation membrane in the membrane module; and
resuming the filtration operation,
wherein preliminary operation satisfying a condition A or a condition B below is performed after the separation membrane is subjected to the chemical cleaning, and the filtration operation is resumed after a characteristic derived from a fouling material in an activated sludge solution satisfies a preset first criterion:
Condition A: air diffusion from the diffuser means having been interrupted during the chemical cleaning of the membrane is resumed; and
Condition B: air diffusion from the diffuser means having been interrupted during chemical cleaning of the membrane is resumed, and preliminary filtration operation is performed at a flux of 40% or less of a flux during the filtration operation,
where the preset first criterion characteristic derived from the fouling material in the activated sludge solution is any one of a turbidity of a filter paper filtrate of the activated sludge solution as defined in Formula 1 below, image information from a microscope showing a floc region as defined in Formula 2 below, and a membrane filtration resistance calculated from a result of a membrane filtration test using a membrane piece as defined in Formula 3 below:
[Turbidity of Filter Paper Filtrate of Activated Sludge Solution]
Turbidity of filter paper filtrate [NTU]≤turbidity of filter paper filtrate before chemical cleaning +4 [NTU] (Formula 1)
[Image Information of Microscope Showing Floc Region]
Total area of flocs with area of 200 μm² or less [μm²]/area of microscopic field [μm²]≤(total area of flocs with area of 200 μm² or less before chemical cleaning [μm²]/area of microscopic field [μm²])×1.3 (Formula 2)
[Membrane Filtration Resistance Calculated from Result of Membrane Filtration Test Using Membrane Piece]
Value of increase in membrane filtration resistance ≤value of increase in membrane filtration resistance before chemical cleaning×2.5 (Formula 3).

2. The method for operating a membrane-separation activated sludge treatment device according to claim 1, wherein:
after the chemical cleaning of the separation membrane, the preliminary operation satisfying the condition A or the condition B is performed,
preparatory operation satisfying a condition C below is performed after the characteristic derived from the fouling material in the activated sludge solution satisfies a preset second criterion, and
the filtration operation is resumed after the characteristic derived from the fouling material in the activated sludge solution satisfies the preset first criterion:
Condition C: air diffusion from the diffuser means is continued, and second preliminary filtration operation is performed at a flux of 50% or more and 80% or less of the flux during the filtration operation,
where the preset second criterion characteristic derived from the fouling material in the activated sludge solution is a turbidity of a filter paper filtrate of the activated sludge solution as defined in Formula 4:
Turbidity of filter paper filtrate [NTU]≤value of turbidity of filter paper filtrate before chemical cleaning+8 [NTU] (Formula 4).

3. (canceled)

4. (canceled)

5. (canceled)

6. The method for operating the membrane-separation activated sludge treatment device according to claim 1, wherein a pore size of the separation membrane used in the membrane module is 0.01 μm or more and less than 1 μm.

7. The method for operating the membrane-separation activated sludge treatment device according to claim 1, wherein:
the characteristic of the activated sludge solution is measured before and after the chemical cleaning, and
normal filtration operation is resumed based on a result of the measurement of the characteristic.

8. The method for operating the membrane-separation activated sludge treatment device according to claim 7, wherein:
information obtained by measuring the characteristic of the activated sludge solution before and after the chemical cleaning is judged by judging means provided at a remote location connected by a communication device,
a control condition related to resumption of the normal filtration operation is output when a judgment result satisfies a preset criterion, and
the normal filtration operation is resumed according to the output control condition.

9. A membrane-separation activated sludge treatment device comprising:
an activated sludge tank configured to hold an activated sludge solution for treating water to be treated;
a membrane module immersed in the activated sludge tank;
diffuser means disposed below the membrane module;
permeated water discharge means configured to discharge permeated water having permeated through the membrane module to outside of the device;
a data storage unit configured to store information on measurement of a characteristic of the activated sludge solution before and after chemical cleaning from after normal filtration operation is performed until the normal filtration operation is resumed after the chemical cleaning of a separation membrane in the membrane module;
a communication device configured to transmit the information to a remote location; and
a controller configured to control resumption of the normal filtration operation based on the characteristic of the activated sludge solution before and after the chemical cleaning.

10. The membrane-separation activated sludge treatment device according to claim 9, wherein
the controller is a management program configured to cause a computer to run as: means for collecting the activated sludge solution; means for measuring the characteristic of the collected activated sludge solution; means for making a judgement based on a result of measuring the characteristic of the activated sludge solution; means for outputting an operation control condition based on a judgement result; and means for resuming the normal filtration operation in accordance with the output control condition, and
a part of the management program is executed via judging means provided at the remote location connected by the communication device.
